(19) United States
(12) Patent Application Publication
(10) Pub. No.: US 2002/0072832 A1
(43) Pub. Date: Jun. 13, 2002

(54) System and method of determining an altitude of an aircraft using barometric pressure measurements

(76) Inventors: Thomas J. Bachinski, Lakeville, MN (US); Eric J. Rach, Burnsville, MN (US); Ben Ping-Tao Fok, Apple Valley, MN (US)

Correspondence Address: CALFEE HALTER & GRISWOLD, LLP, 800 SUPERIOR AVENUE, SUITE 1400, CLEVELAND, OH, 44114, US

(21) Appl. No.: 09/734,363

(22) Filed: Dec. 11, 2000

(51) Int. Cl. G05D 1/00

(52) U.S. Cl. 701/4; 342/38; 340/967

(57) ABSTRACT

A system for determining an altitude of an aircraft using barometric pressure measurements is disclosed comprising: a transmitter disposed at a ground station for transmitting a signal to the aircraft, which signal including first data representative of barometric pressure at the ground station; a receiver disposed at the aircraft for receiving the transmitted signal; sensing apparatus disposed at the aircraft for measuring barometric pressure at the altitude of the aircraft and generating second data representative thereof; and processing circuitry for determining the altitude of the aircraft based on the first and second data and data representative of the elevation of the ground station. The ground station includes sensing apparatus for measuring barometric pressure at the ground station and generating pressure data representative thereof which is superimposed onto a carrier signal of the transmitter for transmission to the aircraft. Also disclosed is a method of determining an altitude of an aircraft using barometric pressure measurements, the method comprising the steps of: transmitting a signal from a ground station to the aircraft, the signal including first data representative of barometric pressure at the ground station; receiving the transmitted signal at the aircraft; measuring barometric pressure at the altitude of the aircraft and generating second data representative thereof; and determining the altitude of the aircraft based on the first and second data and data representative of the elevation of the ground station. The method may further include the steps of determining a position of the aircraft and generating a position signal representative thereof; storing data representative of elevations of the terrain under a flight path of the aircraft; accessing the stored terrain elevation data based on the position signal; and determining aircraft AGL at an aircraft position based on the determined altitude and the accessed terrain elevation data at the aircraft position.

### BACKGROUND OF THE INVENTION

This invention is directed to aircraft altitude measuring systems, in general, and more particularly to a system and method of determining an altitude of an aircraft using barometric pressure measurements from the aircraft and a ground station, and the elevation of the ground station.

Aircraft altitude is conventionally measured by a radar altimeter device located on the aircraft. Such devices operate by transmitting signals to the ground below and receiving echo signals therefrom which are processed in a post processor for calculating the aircraft altitude. Radar altimeters are expensive devices and for some aircraft may be considered cost prohibitive. In addition, radar type devices generally suffer from false echo reflections that may cause inaccurate readings. Another type of device for measuring aircraft altitude is a laser altimeter which is an optical based system which transmits light signals to the ground below and receives light echoes therefrom that undergo post processing to effect the altitude reading. Not only are these type devices very expensive, the effectiveness thereof is weather condition limited. Also, they are not considered very effective over water. Still further, environmental conditions such as dirt and debris, for example, may affect the performance thereof.

The present invention overcomes the drawbacks of the foregoing described altimeters and provides an aircraft altitude measurement device that is less expensive and considered more accurate that those currently employed.

### SUMMARY OF THE INVENTION

In accordance with one aspect of the present invention, a system for determining an altitude of an aircraft using barometric pressure measurements comprises: a transmitter disposed at a ground station for transmitting a signal to the aircraft, which signal including first data representative of barometric pressure at the ground station; a receiver disposed at the aircraft for receiving the transmitted signal; sensing means disposed at the aircraft for measuring barometric pressure at the altitude of the aircraft and generating second data representative thereof, and processing means for determining the altitude of the aircraft based on the first and second data and data representative of the elevation of the ground station.

In accordance with another aspect of the present invention, a ground station for transmitting data to an aircraft that is used in determining an altitude of the aircraft comprises: sensing means for measuring barometric pressure at the ground station and generating pressure data representative thereof; a transmitter for transmitting a carrier signal to the aircraft; and means for superimposing the pressure data onto the carrier signal for transmission to the aircraft.

In accordance with yet another aspect of the present invention, apparatus disposed at an aircraft for determining an altitude of the aircraft using barometric pressure measurements comprises: a receiver for receiving a signal transmitted from a ground station, said signal including first data representative of barometric pressure at the ground station; sensing means for measuring barometric pressure at the altitude of the aircraft and generating second data representative thereof; and processing means for determining the altitude of the aircraft based on the first and second data and data representative of the elevation of the ground station.

In accordance with yet another aspect of the present invention, a method of determining an altitude of an aircraft using barometric pressure measurements comprises the steps of: transmitting a signal from a ground station to the aircraft, the signal including first data representative of barometric pressure at the ground station; receiving the transmitted signal at the aircraft; measuring barometric pressure at the altitude of the aircraft and generating second data representative thereof; and determining the altitude of the aircraft based on the first and second data and data representative of the elevation of the ground station.

### BRIEF DESCRIPTION OF THE DRAWINGS

FIG. 1 is an illustration of an environment in which the present invention may operate.

FIG. 2 is a block diagram schematic of a system for determining an altitude of an aircraft suitable for embodying the principles of the present invention.

FIG. 3 is a block diagram schematic of a ground station suitable for embodying one aspect of the present invention.

FIG. 4 is a block diagram schematic of apparatus disposed at an aircraft suitable for embodying another aspect of the present invention.

FIG. 5 is a circuit schematic of circuitry suitable for use in the ground station embodiment depicted in FIG. 3.

FIG. 6 is a circuit schematic of a voltage-to frequency circuit and other circuitry suitable for use in the ground station embodiment of FIG. 3.

FIG. 7 is a circuit schematic of a bandpass filter suitable for use in the apparatus of FIG. 4.

FIG. 8 is a circuit schematic of a rectifier and filter suitable for use in the apparatus of FIG. 4.

FIG. 9 is an exemplary timing diagram for data transmission between the ground station and aircraft suitable for use by the embodiments of FIGS. 3 and 4.

FIGS. 10 and 11 are exemplary software flowcharts suitable for use in programming the controller in the embodiment of FIG. 3.

FIGS. 12 and 13 are exemplary software flowcharts suitable for use in programming the controller in the embodiment of FIG. 4.

FIG. 14 is a block diagram schematic of an alternate embodiment of the present invention.

FIG. 15 is an exemplary software flowchart suitable for use in programming the controller in the embodiment of FIG. 14.

FIG. 16 is an illustration of an environment in which the present invention may be embodied.

### DETAILED DESCRIPTION OF THE INVENTION

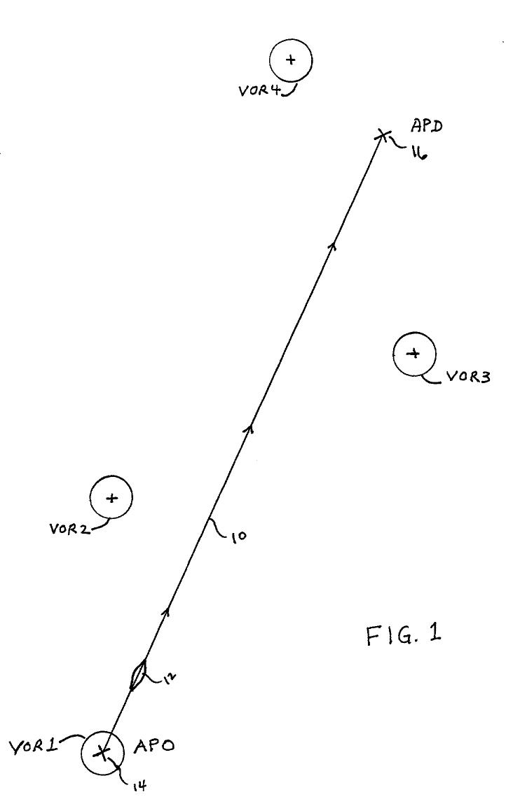

FIG. 1 is an illustration of an environment in which an embodiment of the invention may operate. Referring to FIG. 1, an arrowed line 10 represents a flight path of an aircraft 12 having an originating airport (APO) 14 and a destination airport (APD) 16. In close vicinity to the flight path 10, the Federal Aviation Authority (FAA) has disposed a plurality of VHF omni-directional range (VOR) ground radio stations illustrated by the circled areas VOR1, VOR2, VOR3 and VOR4, for example. VOR1 is shown disposed at the originating airport 14. Generally, the VORs are disposed within approximately 50 miles of each other. Each VOR ground station includes a VHF radio transmitter that transmits a carrier signal in the frequency range of 108 to 117.95 MHz to aircraft in the vicinity thereof to assist the pilots of the aircraft in maintaining their planned flight path. VOR receivers disposed at the aircraft receives the transmitted carrier signals from the VOR transmitters and can detect the direction from which the signals are transmitted. A VOR transmitted signal may also carry voice and data signaling to the aircraft for communicating information to the pilot thereof. While VOR ground stations and their aircraft receivers are described in connection with the present embodiment, it is understood that other ground stations and aircraft receivers may be used just as well without deviating from the broad principles of the present invention.

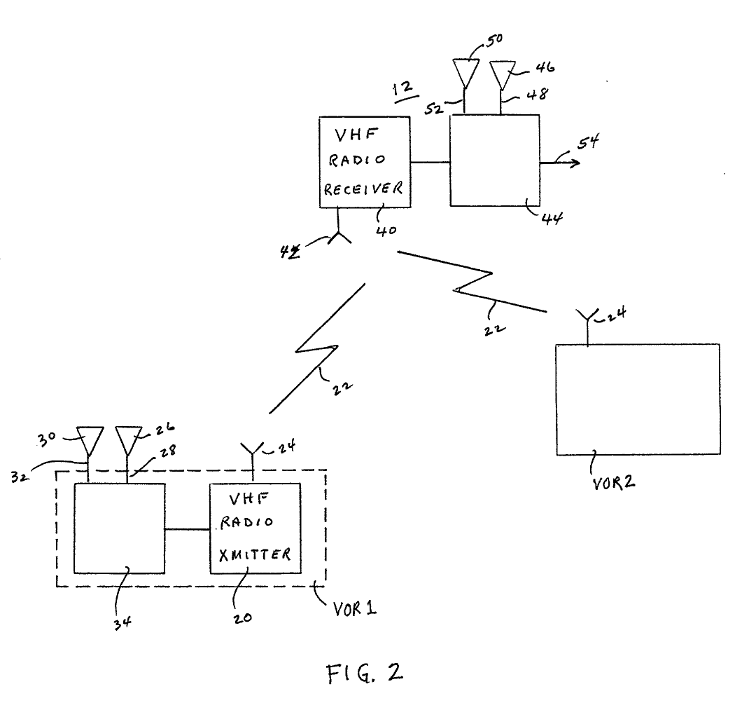

FIG. 2 is a block diagram schematic of a system for determining the altitude of an aircraft suitable for embodying the principles of the present invention. Referring to FIG. 2, each VOR ground station, like VOR1 and VOR2, for example, includes a conventional VHF radio transmitter 20 for transmitting a VHF carrier signal 22 to the aircraft 12 via a conventional VOR antenna 24. In the present embodiment, each ground station includes a pressure sensor 26 for measuring the barometric pressure at the ground station and generating a signal 28 representative thereof. A temperature sensor 30 may also be included for measuring the temperature at the ground station and generating a signal 32 representative thereof. In the present embodiment, the pressure and temperature signals are generated as electrical analog signals by way of example. Electronic signal conditioning and processing of the pressure and temperature signals 28 and 30 are performed by block 34 as will be more fully explained in the description herein below. Block 34 also superimposes data representative of the pressure measurement at the ground station, and possibly the temperature measurement as well, onto the carrier signal 22 which is being transmitted to the aircraft 12.

At the aircraft 12 is disposed a conventional VHF radio receiver 40 for receiving VOR carrier signals 22 and signals superimposed thereon via a conventional antenna 42. Also, at the aircraft 12 is an electronic signal conditioning and processing block 44 which is coupled to the radio receiver 40 and operative to separate the superimposed data from the received carrier signal for processing therein as will be more fully explained by the following description. A pressure sensor 46 is located at the aircraft 12 for measuring barometric pressure and generating an electrical analog signal 48 representative thereof which is coupled to the electronics of block 44. A temperature sensor 50 may also be located at the aircraft 12 for measuring temperature and generating an electrical analog signal 52 representative thereof which may also be coupled to the electronics of block 44. The processing block 44 determines the altitude of the aircraft 12 based on the pressure signals of the ground station and aircraft and the elevation of the VOR ground station. Note that where temperature signals exist, the corresponding pressure signals may be compensated for temperature in the processing block 44, for example, prior to altitude determination for better accuracy. Altitude data of the aircraft may be output over line(s) 54 to other systems of the aircraft, like a host computer and cockpit display, for example. Also, when the receiver 40 of the aircraft 12 is receiving transmitted signals from a plurality of VOR ground stations, like VOR1 and VOR2, as exemplified in the illustration of FIG. 2, it may choose the strongest of the received signals, which is an indication of the proximity of the ground station to the aircraft, as the signal from which to obtain pressure and elevation data. But, it is understood that another selection process may work just as well.

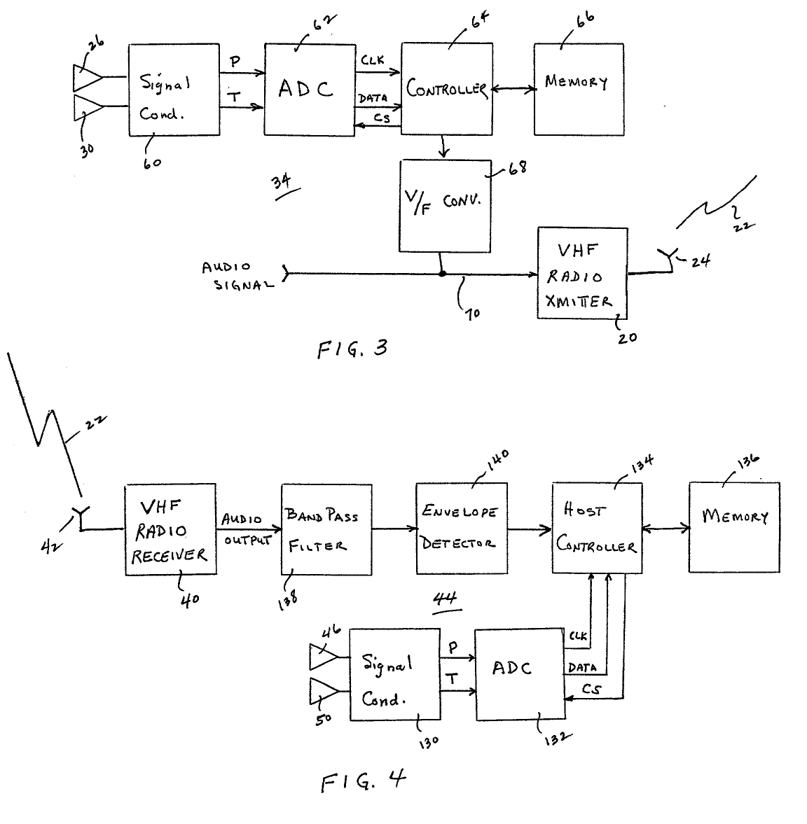

FIG. 3 is a block diagram schematic of a ground station suitable for embodying one aspect of the present invention. Referring to FIG. 3, the pressure sensor 26 and possibly, temperature sensor 30, are coupled to a signal conditioning block 60 which effects an analog pressure signal P and analog temperature signal T. The analog signals P and T are coupled to an analog-to-digital converter (ADC) 62 wherein they are digitized into digital data words that are transferred to a processing circuit or controller 64 over signal line DATA. A clock signal may be generated by the ADC 62 and supplied to the processing circuit 64 over line CLK for synchronizing a serial data transfer of pressure and temperature data words. The circuit 64 may select which of the P and T signals are being digitized by a control signal applied to the ADC 62 over line CS. The processing circuit 64 may be a programmed microcontroller of the conventional variety, like a PIC 12C508, for example, the programming of which being described in greater detail herein below. A digital word memory 66 which may be an integral part of the microcontroller 64 or separated therefrom is used to store the digitized data words of the analog pressure and temperature signals and other data as will become better understood from the description below. In addition, a voltage to frequency (V/F) converter 68 is coupled between the controller 64 and an audio signal line 70 of the radio transmitter 20. The audio signal line 70 is generally used to conduct voice signaling from a microphone, for example, to the transmitter 20 for transmission on the carrier to the aircraft. Accordingly, audio frequency keying via the V/F converter 68 controlled by the controller 64 permits transmission of pressure data and temperature data as audio signaling superimposed on the carrier signal 22.

The block diagram embodiment of FIG. 3 is exemplified in more specific detail in the circuit schematics of FIGS. 5 and 6. Referring to FIG. 5, a DC power supply of an approximate voltage potential of 12 volts is used in the present embodiment to power the circuitry. The 12V supply is coupled to a voltage regulator 72 which may be of the type manufactured by Analog Devices bearing model number AD586, for example, to produce a precision reference voltage which may be on the order of 5 volts, for example. A solid-state pressure sensor (SSPS) 74 of the strain gauge type, for example, is used in the present embodiment to measure both pressure and temperature and generate signals representative thereof. A suitable SSPS for the present embodiment is manufactured by BFGoodrich Aircraft Sensors Division, bearing part number 02011-0017, which includes a resistance bridge circuit 76 which is powered at one end 78 by the 5V reference potential. Current exiting at the other end 80 of the bridge is conducted through a resistor 82 to ground potential or signal common. Resistance nodes 86 and 88 of the bridge are coupled respectively to (+) and (−) inputs of an instrumentation amplifier which may be of the type manufactured by Analog Devices, bearing model number AD623, for example, for measuring the potential difference across the nodes of the bridge. A resistor 92 is coupled across the RG pins of the amplifier 90 and the REF pin thereof is coupled to ground potential. The amplifier 90 is powered by the 12V supply via a resistor and capacitor filter network, 94 and 96, respectively. The output of the amplifier 90 which is the analog signal representative of the pressure measurement is coupled to a channel zero (CH0) input of the A/D converter 62 which may be of the type manufactured by Linear Technology, bearing model number LT1298, for example. In one embodiment, the SSPS is calibrated to range from 1 to 17 PSI full scale.

In addition, the circuit node between the resistor 82 and resistor bridge 76 is coupled to a (+) input of an operational amplifier 100 which is configured as a unity gain amplifier. The output of the amplifier 100 is coupled to a (+) input of another operational amplifier 102 configured as a low pass filter circuit having a pass band of approximately one-hundred hertz (100 Hz). More specifically, a parallel resistance capacitor network comprising resistor 104 and capacitor 106 is coupled between the output and a (−) input of amplifier 102 which is also coupled to the node of a resistor divider network comprising resistors 108 and 110 powered by the 5V reference voltage to provide an offset. The output of the amplifier 102 which is the analog signal representative of the temperature measurement is coupled to a channel one (CH1) input of the converter 62. The operational amplifiers 100 and 102 which may be of the type manufactured by Analog Devices, Inc., bearing model number AD623, for example, are powered by the 12V supply via a series resistor capacitor filter network comprising resistor 112 and capacitor 114. In one embodiment, the calibrated temperature range spans from 0 C. to 70 C.

Referring to FIG. 6, the voltage-to-frequency circuit 68 is configured about an integrated circuit (IC) 116 which may be of the type manufactured by Analog Devices bearing model number AD654, for example. The input (VIN) of the IC 116 is kept constant and logically high by the 12V supply via a resistor R1. A diode D1 is coupled from the input VIN to ground potential to prevent VIN from going substantially negative as a result of possible noise spikes on the 12V supply. The output frequency at FOUT of the IC 116 is set at approximately 2.5 KHz by the values of resistor R2 and capacitor C1 coupled to the IC 116 and oscillates between 0 and 5V due to the pull up resistor R3 being coupled to the reference 5V supply. Resistor R2 may be made adjustable so that the output frequency may be adjusted between 1 KHz and 20 KHZ, for example. The 12V supply is controllably supplied to the +VS input of the IC 116 via a digital output of the controller 64. A series resistor capacitor network comprising resistor R10 and capacitor C2 provides filtering of the switched power supply. Accordingly, the microcontroller 64 may frequency key the ones and zeros of a digital word at the output FOUT of the IC 116 by controlling the 12V supply thereto. A low frequency high pass filter comprising capacitor C3 and resistor R4 is used to de-couple the output frequency signal FOUT from its DC component and the de-coupled signal is provided to a unity gain amplifier comprising operational amplifier 118 so that the high pass filter of C3-R4 will not be loaded down. The output of amplifier 118 is controlled to be centered about the 5V reference voltage by a second amplifier circuit comprising operational amplifier 120 and resistors R5 and R7. The resulting audio keyed signal is passed through the audio input line 70 of the VHF transmitter 20 to be combined with the audio signal via a de-coupling circuit comprising resistor R6 and parallel capacitors C4 and C5. In addition, a pull-up resistor R9 couples the audio line 70 to the 12V supply to provide proper operation thereof. The operational amplifiers 118 and 120 are powered by the 12V supply via a series resistor capacitor filter network comprising resistor R8 and capacitor C6.

In operation, as the barometric pressure at the location of the sensor 74 changes, the bridge circuit 76 thereof incurs a proportional resistance change which is detected as a differential voltage by the amplifier 90 and the resulting analog signal which is representative of the barometric pressure measurement is provided to the CH0 input of the ADC 62. Similarly, as the temperature changes, the bridge resistance will incur a proportional change which alters the current of resistor 82 resulting in an IR potential across resistor 82 that is a measure of the temperature thereat. The resulting IR voltage signal is conditioned by the amplifier circuits 100 and 102 and provided to the CH1 input of the ADC 62. Upon command of the microcontroller 64, the channels CH0 and CH1 are selected and the analog signals thereof digitized by the ADC 62. The microcontroller 64 accepts the resulting digital words representative of the measured barometric pressure and corresponding temperature over the DATA lines and stores them in designated memory locations of the memory 66. In the present embodiment, each digital word is 12 bits. The microcontroller 64 may thereafter access the digital words from memory 66 and control the V/F converter 68 to superimpose by frequency keying the states of the bits of the digital words onto the transmitted carrier of the transmitter 20 which is transmitted to the aircraft 12. The microcontroller 64 utilizes the embodiment described in connection with FIG. 6 to frequency key the bits of the digital words onto the audio signal input of the transmitter 20. For example, if the state of a bit is a logical “1”, then the microcontroller 64 switches power to the IC 116 so that it may generate a frequency output signal. Likewise, if the state of a bit is a logical “0”, then no power is switched to the IC 116 and thus, no frequency signal is generated. In this manner, the frequency output of IC 116 may be toggled in accordance with the states of the bits of the digital words to be transmitted on the carrier signal to the aircraft 12.

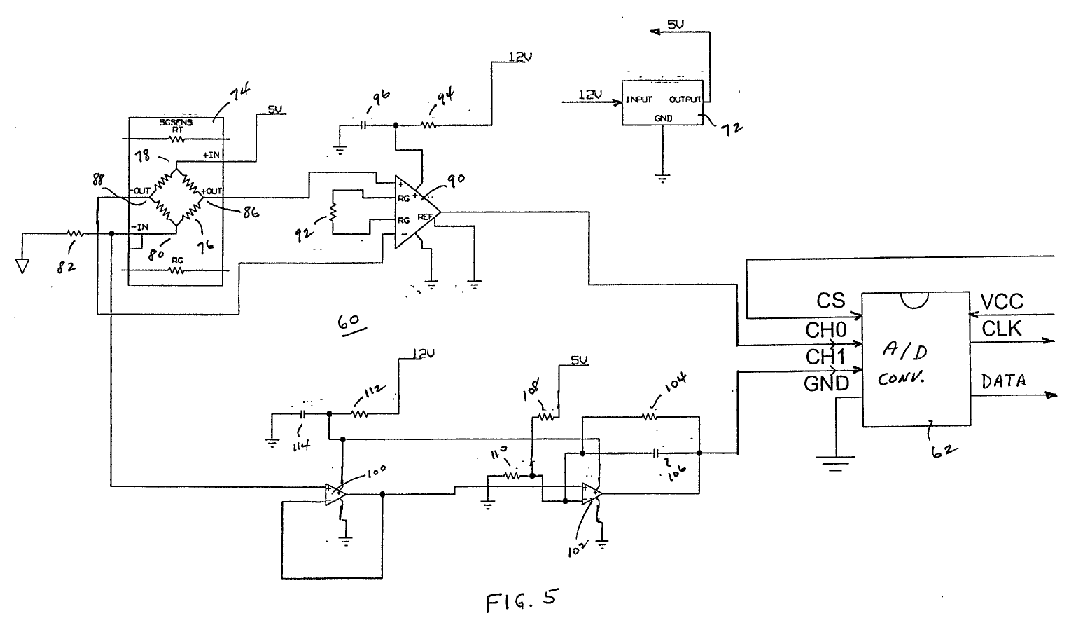

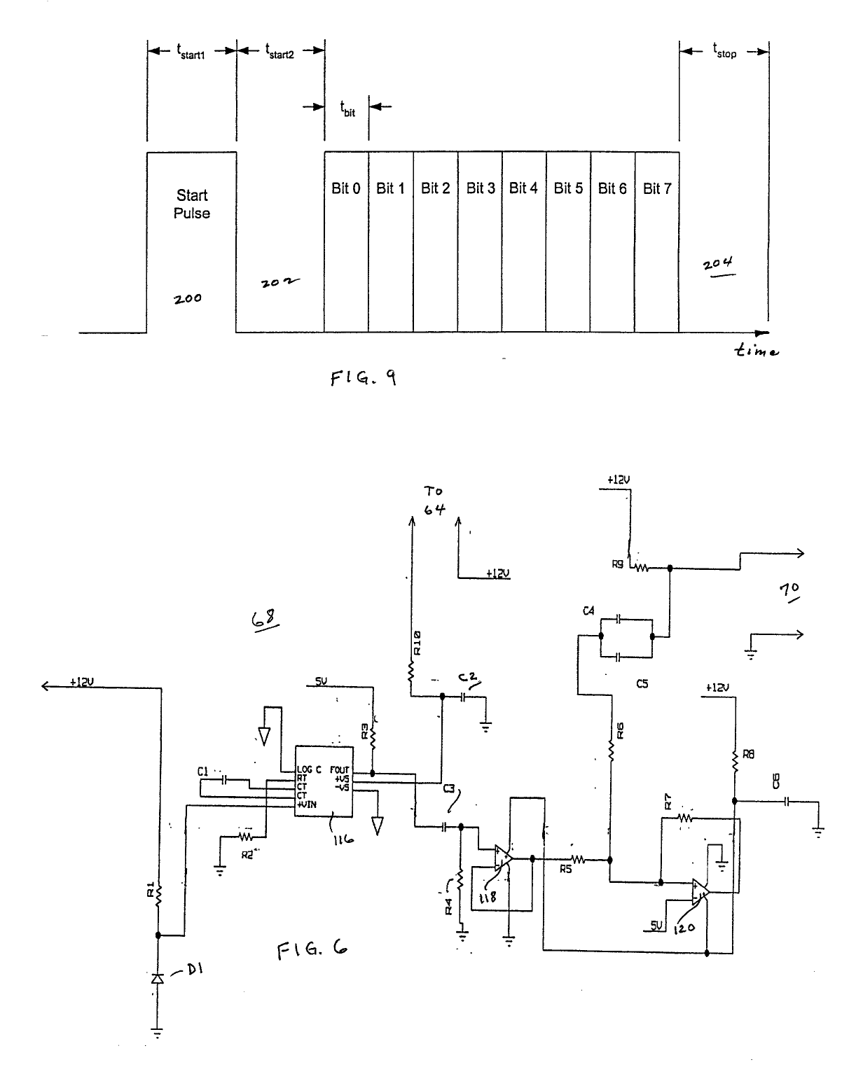

FIG. 4 is a block diagram schematic of electronic apparatus disposed at the aircraft 12 suitable for embodying another aspect of the present invention. Referring to FIG. 4, the pressure sensor 46 and possibly, temperature sensor 50, are coupled to a signal conditioning block 130 which effects an analog pressure signal P and analog temperature signal T. The analog signals P and T are coupled to an analog-to-digital converter (ADC) 132 wherein they are digitized into digital data words that are transferred to a processing circuit or controller 134 over signal line DATA. A clock signal may be generated by the ADC 62 and supplied to the processing circuit 64 over line CLK for synchronizing a serial data transfer of pressure and temperature data words. The controller 134 may select which of the P and T signals are being digitized by a control signal applied to the ADC 132 over line CS. The processing circuit 134 may be a programmed microcontroller of the conventional variety, like a PIC 12C508, for example, the programming of which being described in greater detail herein below. A digital word memory 136 which may be an integral part of the microcontroller 134 or separated therefrom is used to store the digitized data words of the analog pressure and temperature signals and other data as will become better understood from the description below. The circuitry embodying the sensors 46 and 50, the signal conditioning block 130 and ADC 132 may be the same or similar to that described for circuits 60 and 62 in FIG. 5.

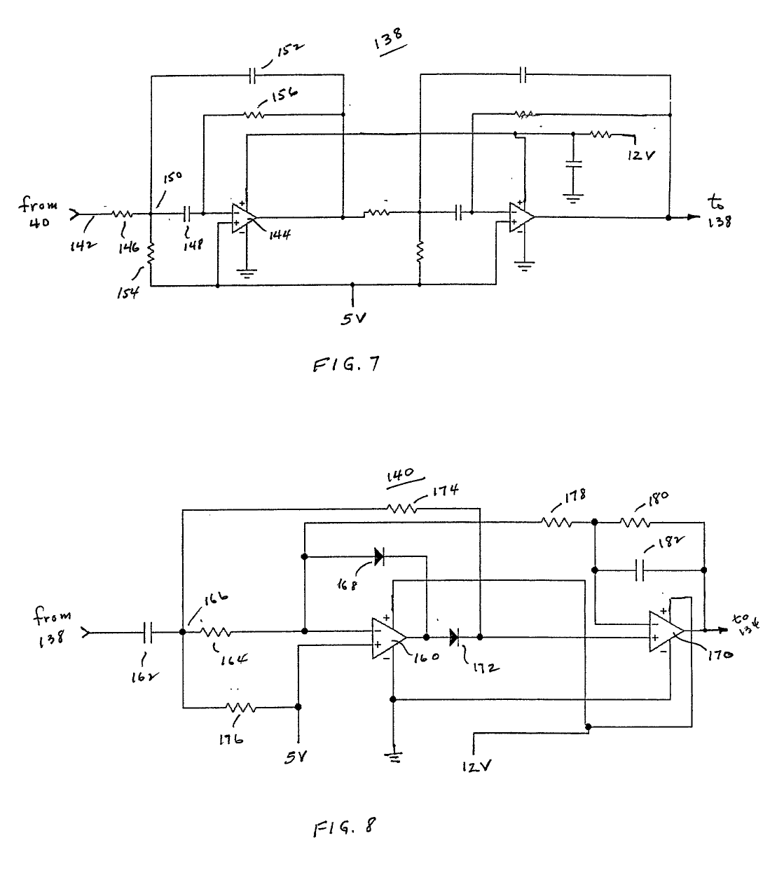

Still referring to FIG. 4, the radio receiver 40 provides conventionally a “Detected Audio Output” which is the signal immediately following AM demodulation. This signal is suitable for the purposes of separating out the frequency keyed date from the audio signaling of the transmitted signal 22 because it is not filtered in the receiver 40. The receiving stages comprise a first stage 138 which may be a second order bandpass filter having a center frequency substantially matched to the frequency keyed signaling which may be on the order of 2.5 KHz, for example, and a second stage 140 which is an envelope detector. The bandwidth of the first stage filter 138 may be on the order of 100 Hz, for example. As will be described in more specific detail in FIG. 7, the second order effect is achieved in the present embodiment by cascading two RCCR first order bandpass filters. Also, the second stage which will be described in more specific detail in connection with the circuit schematic of FIG. 8 includes a full wave rectifier and a low pass filter. The full wave rectifier is chosen because it produces less ripples on the demodulated signal output of the first stage. Each serial digital word output of the second stage 140 is provided to the microcontroller 134 which stores the words in memory for later processing. The programmed operation of the microcontrollers 64 and 134 will be described in more specific detail herein below.

The circuit schematic of the first stage 138 shown in FIG. 7 comprises two cascaded RCCR first order bandpass filters which are identically configured. Accordingly, for the sake of brevity, only the first filter circuit will be described since the other is an identical pair. Referring to FIG. 7, the audio output signal 142 of receiver 40 is coupled to a (−) input of an operational amplifier 144 through a series resistor capacitor network comprising resistor 146 and capacitor 148. The node 150 of the 146-148 connection is coupled to the output of the amplifier 144 through a capacitor 152 and is pulled up to the 5V reference supply through a resistor 154. The (−) input of amplifier 144 is also coupled to the output thereof through a resistor 156. The circuit component values of the aforementioned described filter are selected to achieve a center frequency of substantially 2.5 KHz with a passband width of approximately 100 Hz, for example. The (+) inputs or virtual grounds of the operational amplifiers are referenced to the 5V supply and the operational amplifiers are powered by the 12V supply via a resistor capacitor filter network. Consequently, the output signal of stage 138 will be the keyed frequency signal representative of the transmitted digital words.

Next, in the circuit schematic of FIG. 8, the frequency content of the first stage output signal is removed to effect a serial digitally modulated signal. Referring to FIG. 8, the input signal is coupled to a (−) input of an operational amplifier 160 through a series capacitor resistor pair, 162 and 164, respectively. The (−) input of 160 is coupled to the output thereof through a diode 168 (anode-to-cathode). Coupled between the output of 160 and the (+) input of another operational amplifier 170 is another diode 172 (anode-to-cathode).The connecting node 166 of the 162-164 pair is also coupled to the (+) input of 170 through a resistor 174. Node 166 is pulled up to the 5V reference potential through a resistor 176. The (+) input of 160 is referenced to the 5V supply. The (−) input of 160 is coupled to the (−) input of 170 through a resistor 178 and a parallel resistor capacitor pair, 180 and 182, respectively, is coupled across the (−) input and output of 170. Both amplifiers 160 and 170 are powered by the 12V supply. The digitally modulated output signal of amplifier 170 is coupled to a digital input of the controller 134. The amplifiers used for the foregoing described embodiments may be of the type manufactured by Analog Devices, Inc. bearing model number OP270, for example.

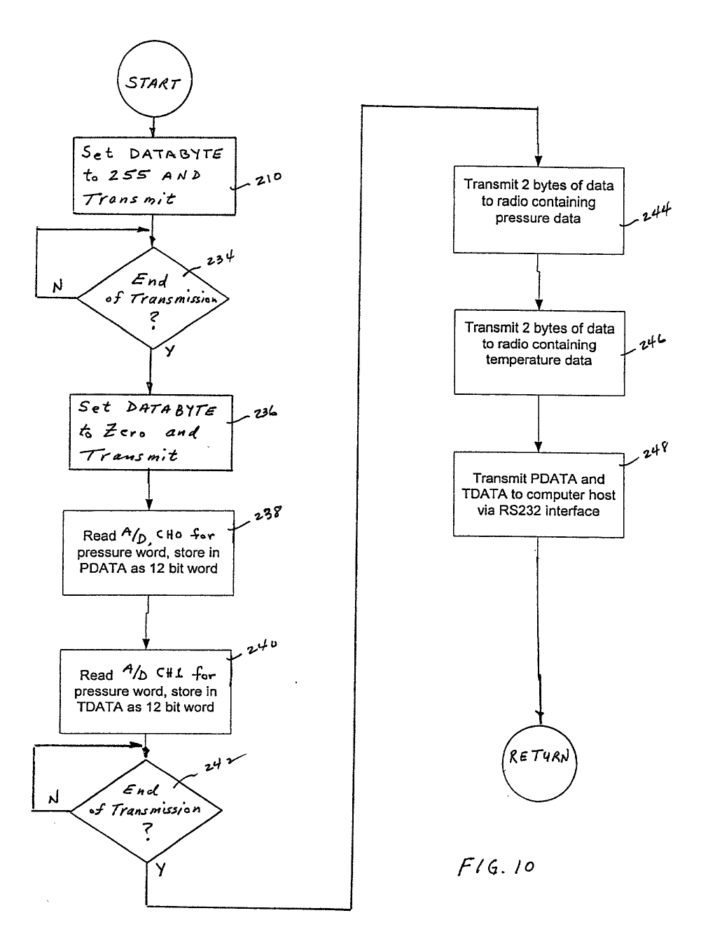

Timing for data transmission and reception between the ground stations and the aircraft is controlled by the controller 64 in the ground stations via the on and off toggling of the V/F converter 68. It is understood that if the time between bits is too short, the receiving circuit in the aircraft may not have enough time to demodulate the incoming data from the transmitted carrier signal and cause an error. A exemplary timing diagram for data transmission is shown in FIG. 9. Referring to FIG. 9, a start pulse (255 byte) 200 is used in the present embodiment to signify incoming data to the receiver. After the transmission of the start pulse, the microcomputer holds the V/F converter 68 low for another pulse (null byte) 202 so that the receiving circuitry as described above has enough time to respond. After the null period 202, each bit of data is transmitted in the form of bytes (8 bit words) starting with the least significant bit (LSB, bit 0). A bit time period, t_{bit}, may be on the order of 15 milliseconds, for example. After each byte is transmitted, the controller 64 maintains a null period 204 to permit the receiving circuits sufficient time to process the transmitted data byte. The start period 200, start null period 202 and stop null period 204 may be as long as the transmission of a data byte, i.e. 8×15 ms, or approximately 120 ms, for example. This will become more evident from the description of the programmed operation of the controllers 64 and 134 herein below.

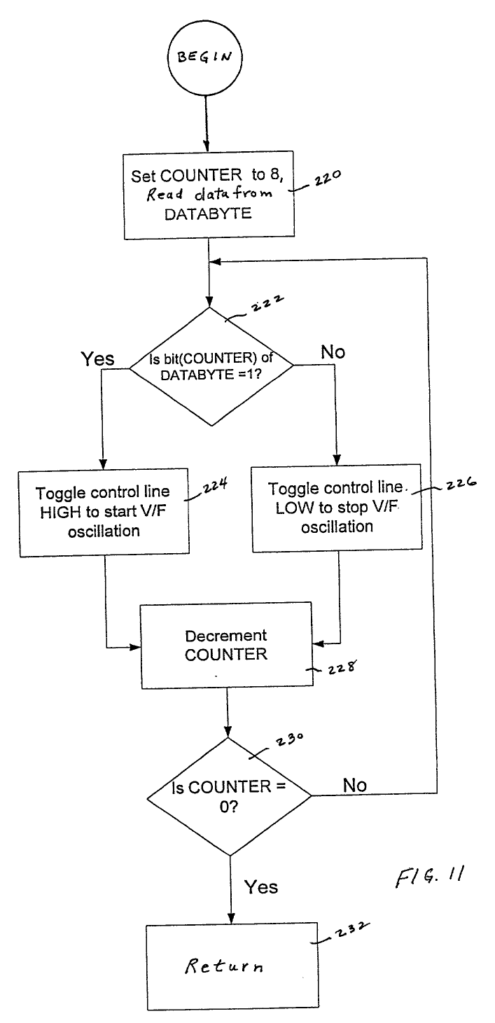

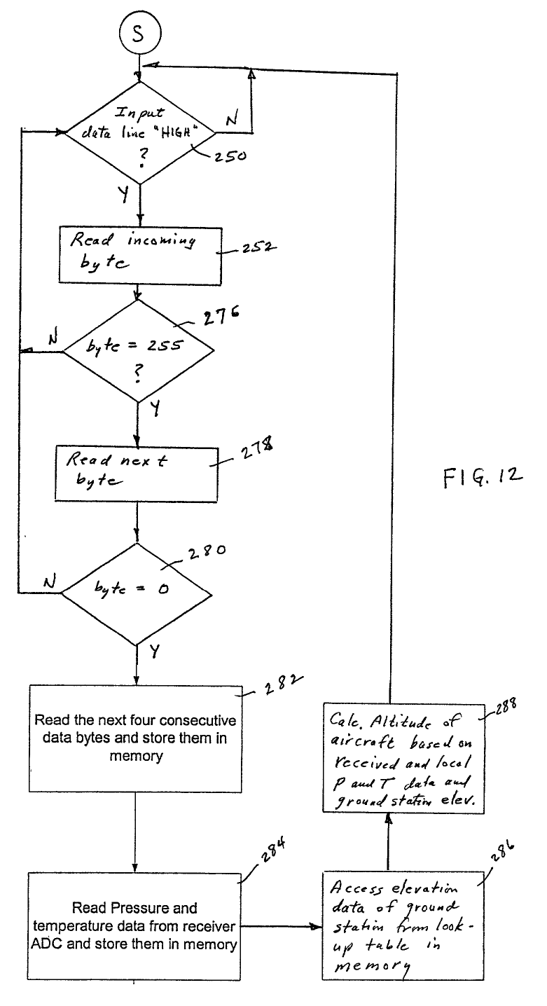

FIGS. 10 and 11 are flowcharts exemplifying the programmed operation of the ground station controller 64. When pressure, and possibly temperature, data is ready to be transmitted from the ground station to the aircraft, the program of FIG. 10 is initiated starting at block 210 wherein a designated byte register of the controller 64 referred to as DATABYTE is set to all “1”s or the binary number 255 and the transmission program of FIG. 11 is executed starting at block 220. In block 220, a counter register COUNTER is set to the binary number 8 and data is read bit by bit from DATABYTE according to the count in COUNTER. For example, starting off COUNTER is set to 8 which represents the LSB of DATABYTE. Next, in decisional block 222, it is determined whether or not the bit of DATABYTE designated by COUNTER is a logical “1”, if so, block 224 toggles a control line to permit power to be supplied to the V/F converter 68 to commence oscillation at the output thereof; if not, the control line is not toggled or toggled low in block 226 to prevent the supply of power to the V/F converter and stop oscillation at its output. At the end of 15 ms, COUNTER is decremented in block 228 and checked if zero count in block 230. If not zero, the blocks 222, 224 or 226, 228 and 230 are repeated until the count of COUNTER is zero which signifies to the program that a byte of data has been transmitted. Upon completion of transmission, a flag may be set by block 232 and the program execution returned to the program flow of FIG. 10 at the decisional block 234, for example.

In block 234, the program monitors the end of transmission flag and if set continues execution at block 236, else it loops about itself awaiting the end of transmission. A software timer may be included in the program flow to protect against an endless looping at block 234. Next, in block 236, DATABYTE is set to zero and the transmission program of FIG. 11 is called. In this manner, the software implements the timing of the start and start null periods, 200 and 202, respectively. During the start null period 202, for example, block 238 causes the controller 64 to activate the ADC 62 to convert the analog pressure measurement into a data word which may be 12 bits for the present embodiment. When the conversion is complete, block 238 also causes the controller to read in the resulting 12 bit pressure data word and store it into designated registers of memory 66 referred to as PDATA. PDATA may include an upper byte register which may store the most significant 4 bits and a lower byte register which may store the remaining 8 bits. If temperature is being measured at the ground station, block 240 may cause the controller 64 to perform the same operations as just described for the temperature measurement and likewise, store the resulting digital word in TDATA. Then, the program waits for the end of transmission flag to be set in block 242. When set, the program next executes block 244 for transmission of the pressure data previously read in at block 238. In this process, DATABYTE maybe set to the contents of the upper byte of PDATA first and transmitted (FIG. 11), then DATABYTE may be set to zero and transmitted, then DATABYTE may be set to the contents of the lower byte of PDATA and transmitted, and finally, DATABYTE may be again set to zero and transmitted. If appropriate, the same steps as described for block 244 may be repeated for the transmission of the upper and lower bytes of TDATA in block 246. If a host computer is included at the ground station, then in block 248, the contents of PDATA and TDATA may be transferred to the host computer via a RS232 interface, for example. Program execution may then be returned to an executive which may execute the program periodically, or on an as needed basis.

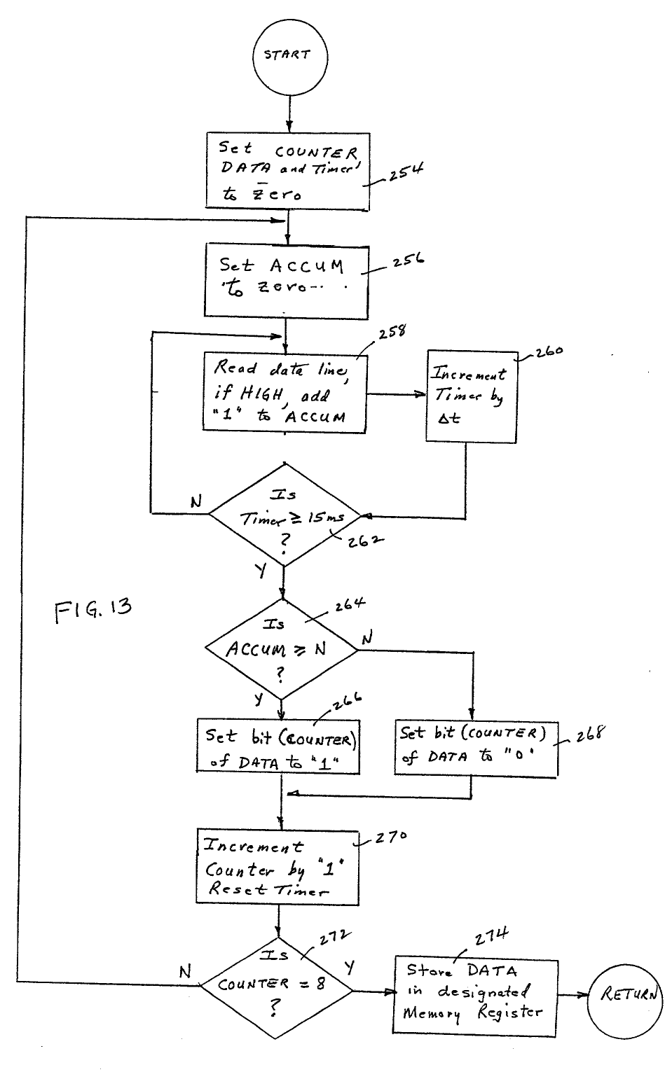

FIGS. 12 and 13 are program flowcharts exemplifying the programmed operation of the aircraft controller 134. Referring to FIG. 12, in decisional block 250, the program monitors the input data line of the controller 134 connected to the output of the envelope detector 140 to determine whether or not data transmission has commenced signified by the line going high or a binary one. If a low is detected on the data line, the program continues to loop around block 250. When a high is detected, the program reads in a data byte in block 252 in accordance with the process exemplified in the flowchart of FIG. 13. Referring to FIG. 13, at block 254, the program sets registers designated as COUNTER and Timer to zero. Next, in block 256, a register designated as ACCUM is set to zero. Then, in block 258, the state of the data line is read and if determined high, a “1” is added to the contents of ACCUM. Next, in block 260, Timer is incremented by a count proportional to a Δt which may be on the order of 0.2 ms for the present embodiment. Then, in decisional block 262, it is determined whether or not the count of Timer is greater than or equal to 15 ms which is the time period set at transmission for a transmitted data bit. If not, blocks 258, 260 and 262 are repeated until Timer reaches or exceeds 15 ms at which time program execution continues at decisional block 264.

In block 264, it is determined whether or not the accumulated count of ACCUM is greater than or equal to a predetermined number N. Note that if the data line is high most of the time during the 15 ms interval, ACCUM will have a high count and vice versa if the data line is low most of the time. The number N may be set in the middle between the highest and lowest expected counts for a 15 ms interval. If ACCUM is greater or equal to N, then a bit in DATA designated by the count in COUNTER will be set to a “1” in block 266; otherwise, the designated bit will remain a “0” by block 268. For example, initially COUNTER is set to zero which designates the LSB of DATA and so on. Next, in block 270, COUNTER is incremented by one and Timer is reset to zero in preparation for the reading of the next successive bit. If the count in COUNTER has not reached 8 as determined by block 272, then the blocks of the program starting at block 256 are again executed to determine the state of the next bit of DATA. Otherwise, the states of all of the bits of DATA have been determined and the contents of DATA which contains the byte serially read in by the program is stored in a designated memory register of 136 and appropriately labeled by block 274. Program execution is then returned to the program of FIG. 12 at block 276.

If the incoming byte is determined to be all “1”s or binary 255 by block 276, it is considered the start byte which is indicative of data transmission being in progress. Thereafter, the next byte is read in by block 278 in accordance with the process flow of FIG. 13 and if this next byte is determined to be the null byte by block 280, then the program knows that the succeeding bytes will be pressure and, if appropriate, temperature data and continues execution at block 282. If either of the decisions of blocks 276 or 280 is negative, then it will be assumed that data transmission has not actually commenced and program execution will be diverted back to decisional block 250 to continue monitoring the input data line.

In block 282, the next four bytes of data will be read in according to the steps of the flowchart of FIG. 13 as described herein above. Two of the bytes will be the upper and lower bytes of PDATA and two of the bytes may be the upper and lower bytes of TDATA, if appropriate. Each set of bytes will be store in designated registers of memory 136 and labeled appropriately. Next, in block 286, elevation data of the ground station from which data is being received is accessed from a look-up table stored in memory 136. Such a look-up table may include at least an elevation for each known ground station that will be transmitting data along the flight path of the aircraft. The controller 134 may determine from which ground station data is being received by using a ground station code in the data being received to access the table, for example. In the alternative, on board avionics may determine the ground station from which data is being received and convey that data to the controller 134 for use in accessing the elevation data from the look-up table in memory. It is also possible that the ground station may transmit its elevation data in the form of data bytes along with the pressure and temperature data to the aircraft. In which case, the controller will read in the elevation data along with the pressure and temperature data of the ground station using the same or similar process as described in connection with the program flowcharts of FIGS. 12 and 13.

If temperature data is available, the controller 134 may compensate the pressure data with its corresponding temperature data using any of the well known compensation methods. For example, the compensated pressure may be calculated in accordance with the following formula:

Pc=a+bx+cy+dx²+ey²+fxy+gx³+hy³+ixy²+jx²y,

where

x is the pressure data,

y is the corresponding temperature data, and

a-j are predetermined coefficients which may be stored in memory 136.

It is also possible for the ground station to perform a pressure compensation for temperature in its controller 64 before transmitting the pressure data to the aircraft. If the pressure data is compensated for temperature, it will make for a more accurate calculation of altitude, but it is understood that using uncompensated pressure data for calculating altitude will not in any way deviate from the broad principles of the present invention. In any event, the controller 134 of the aircraft will have barometric pressure data P1 and elevation data E of the ground station and barometric pressure data P2 of the aircraft from which it may calculate the altitude of the aircraft in block 288. For example, the controller 134 may calculate an altitude that each pressure P2 and P1 represents by use of a formula or an altitude vs. pressure look-up table stored in memory 136. All coefficients for the pressure and altitude calculation may be stored in the memory 136 or generated using an altitude vs. pressure look-up table, for example. Thereafter, the altitude determined for pressure P1 may be subtracted from the altitude determined for pressure P2 and an altitude delta obtained. Then, the altitude delta may be added to the ground station elevation to yield the current altitude of the aircraft which may be stored in memory 136 and also conveyed to other avionics of the aircraft and to a cockpit display thereof.

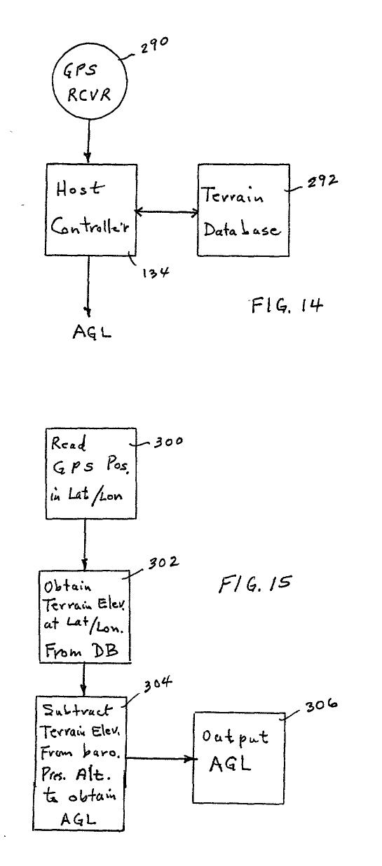

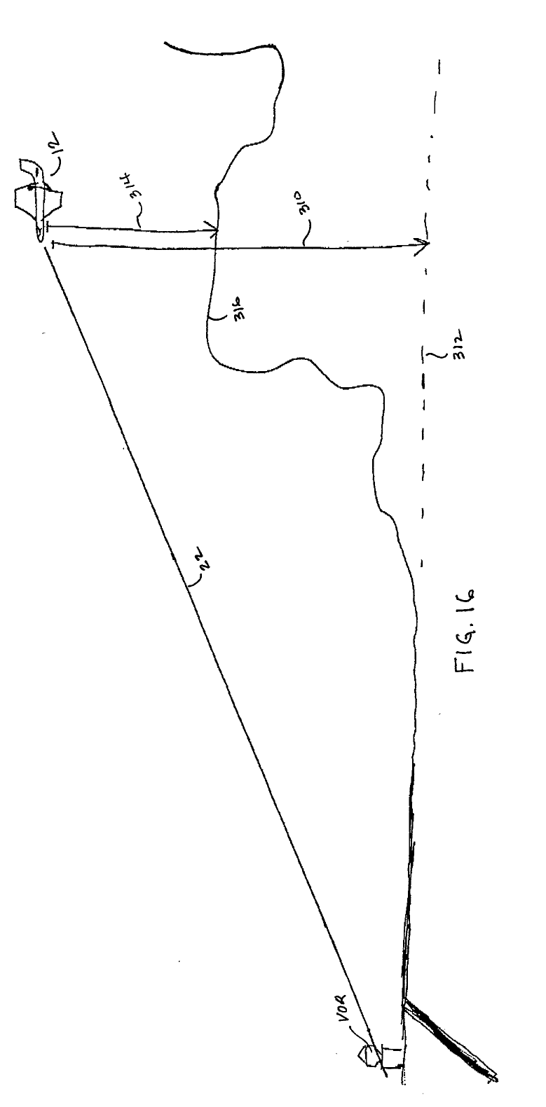

It is also desirable and preferred to determine the altitude above ground level (AGL) at the aircraft. The exemplary diagram of FIG. 16 illustrates the AGL altitude of the aircraft 12. In this example, the aircraft 12 receives the transmitted signal 22 from the ground station VOR which signal includes the pressure and elevation information of the ground station as described herein above. In addition, the aircraft 12 includes apparatus as described herein above to determine the pressure at the aircraft. Thus, from the pressure readings of the aircraft 12 and ground station VOR, the difference in elevation therebetween depicted by line 310 may be determined at the aircraft. Also, the elevation 312 of the ground station with respect to some predetermined reference, like sea level, for example, may be added to the elevation differential 310 to yield the altitude of the aircraft with respect to the predetermined reference. However, this is not the AGL altitude of the aircraft 12. Rather, the aircraft AGL altitude, which is depicted in the illustration of FIG. 16 by the line 314, is the aircraft's elevation above the terrain 316 over which it is flying. A suitable embodiment for determining this aircraft AGL altitude is described herein below in connection with FIGS. 14 and 15.

In an alternate embodiment of the present invention depicted in the block diagram schematic of FIG. 14, the controller 134 of the aircraft may have access to the position of the aircraft through a position determining source, like a conventional GPS receiver 290, for example. If the aircraft is equipped with a GPS receiver, the controller 134 may be interfaced with the receiver 290 through any of the well known conventional methods to read in aircraft position data, preferably in longitude/latitude coordinates. The aircraft position data may be stored in the memory 136. It is understood that use of the GPS receiver 290 in the present embodiment is merely by way of example to show a source of determining aircraft position. Accordingly, any source of determining aircraft position, like multiple radio signal triangulation, for example, may be used without deviating from this aspect of the present invention. In fact, the aircraft position may even be determined externally and transmitted to the aircraft from a ground station is the same manner as that described for the pressure and temperature data, for example.

Still referring to the embodiment of FIG. 14, the aircraft may also include a terrain data base 292 which may also be stored its memory 136 (not shown). The terrain data base 292 may at least include data representing elevations of the terrain under a flight path of the aircraft at various aircraft positions with respect to the predetermined reference elevation. Accordingly, the controller 134 may access terrain elevation data from the data base 292 based on the position of the aircraft. An exemplary flowchart of such programmed operation of controller 134 is illustrated in FIG. 15. Referring to FIG. 15, in block 300, the controller 134 reads in the data of the longitude and latitude position of the aircraft effected by the GPS receiver 290, for example. Next, in block 302, terrain elevation data is accessed from the data base 292 based on the aircraft position data. Then, in block 304, the terrain elevation data is subtracted from the determined altitude of the aircraft to obtain the above ground level (AGL) of the aircraft. The AGL data may be output from the controller 134 to other avionics of the aircraft and to a cockpit display thereof in block 306 to alert the pilot of the aircraft's proximity to the ground.

In another aspect of the present invention, the controller 134 may be programmed to determine the projected flight path of the aircraft from other avionics of the aircraft, like the navigation system, for example. Such flight path information may even be stored in the memory 136 of the aircraft for access by the programmed controller 134, for example. Thus, the controller 134 may select various projected aircraft positions along the flight path thereof and determine the AGL of the aircraft for each projected aircraft position using the process described above in connection with the flowchart of FIG. 15, for example. The aircraft altitude used for the projected AGL determination may be the current determined altitude or some other determined altitude based on the projected flight path of the aircraft, for example. In any case, these determined AGLs may be compared with predetermined safe AGLs based on the speed and trajectory of the aircraft. Accordingly, warnings of unsafe AGLs may be provided to the pilot through visual and oral alarms and even through a visual display in the cockpit, for example. In this manner, the pilot may be forewarned of potential unplanned collisions with the ground and allowed sufficient time to alter the flight path and avoid such collisions.

While the present invention has been described herein above in connection with various embodiments, it is understood that the invention is being presented through such embodiments merely by way of example, and in no way, shape or form should such embodiments be used to limit the invention. Rather, the present invention and all of its aspects should be construed in breadth and broad scope in connection with the recitation of the appended claims hereto.

What is claimed is:

1. System for determining an altitude of an aircraft using barometric pressure measurements, said system comprising:
a transmitter disposed at a ground station for transmitting a signal to said aircraft, said signal including first data representative of barometric pressure at said ground station;
a receiver disposed at said aircraft for receiving said transmitted signal;
sensing means disposed at said aircraft for measuring barometric pressure at the altitude of said aircraft and generating second data representative thereof; and
processing means for determining the altitude of said aircraft based on said first and second data and data representative of the elevation of said ground station.

2. The system of claim 1 including a second sensing means disposed at the ground station for measuring barometric pressure at the ground station and generating the first data representative thereof.

3. The system of claim 2 wherein the second sensing means includes a solid-state pressure sensor (SSPS).

4. The system of claim 3 wherein the SSPS comprises a resistance bridge strain sensor.

5. The system of claim 2 wherein the second sensing means generates an analog signal representative of the measured pressure and includes means for digitizing the analog signal into a digital data word.

6. The system of claim 2 wherein the transmitter comprises means for superimposing the first data onto a carrier of the transmitted signal.

7. The system of claim 6 wherein the superimposing means includes means for frequency keying the first data onto the carrier of the transmitted signal.

8. The system of claim 2 including a third sensing means disposed at the ground station for measuring temperature at the ground station and generating third data representative thereof; and wherein the transmitter comprises means for superimposing the first and third data onto a carrier of the transmitted signal.

9. The system of claim 2 wherein the second sensing means comprises a solid state sensor for measuring both barometric pressure and temperature at the ground station and generating first and third data respectively representative thereof.

10. The system of claim 1 wherein the transmitter comprises a VHF radio transmitter.

11. The system of claim 1 wherein the first data is superimposed onto a carrier of the transmitted signal; and wherein the receiver includes means for separating the first data from the carrier.

12. The system of claim 1 wherein the sensing means includes a solid-state pressure sensor (SSPS).

13. The system of claim 12 wherein the SSPS comprises a resistance bridge strain sensor.

14. The system of claim 1 wherein the sensing means generates an analog signal representative of the measured pressure and includes means for digitizing the analog signal into a digital data word.

15. The system of claim 1 including a third sensing means disposed at the aircraft for measuring temperature at the aircraft and generating third data representative thereof; and wherein the processing means includes means for compensating the second data with the third data.

16. The system of claim 1 wherein the sensing means comprises a solid state sensor for measuring both barometric pressure and temperature at the aircraft and generating second and third data respectively representative thereof.

17. The system of claim 1 including a memory for storing elevation data of the ground station; and wherein the processor includes means for determining the altitude of said aircraft based on said first and second data and elevation data of the ground station accessed from said memory.

18. The system of claim 1 including means for determining a position of said aircraft and generating a position signal representative thereof; a terrain data base for storing data representative of elevations of the terrain under a flight path of the aircraft; and means for accessing terrain elevation data from said data base based on the position signal.

19. The system of claim 18 wherein the processing means includes means for determining aircraft AGL at an aircraft position based on the determined altitude and the accessed terrain elevation data at said aircraft position.

20. The system of claim 18 wherein the position determining means comprises a GPS receiver.

21. The system of claim 18 wherein the processing means includes means for determining projected aircraft AGL along a flight path of the aircraft based on determined altitude of the aircraft and accessed terrain elevation data based on projected positions of the aircraft along said flight path.

22. The system of claim 1 wherein the receiver comprises a VHF radio receiver.

23. A ground station for transmitting data to an aircraft that is used in determining an altitude of the aircraft, said ground station comprising:
sensing means for measuring barometric pressure at the ground station and generating pressure data representative thereof;
a transmitter for transmitting a carrier signal to said aircraft; and
means for superimposing said pressure data onto the carrier signal for transmission to said aircraft.

24. The ground station of claim 23 wherein the sensing means includes a solid-state pressure sensor (SSPS).

25. The ground station of claim 24 wherein the SSPS comprises a resistance bridge strain sensor.

26. The ground station of claim 23 wherein the sensing means generates an analog signal representative of the measured pressure and includes means for digitizing the analog signal into a digital data word.

27. The ground station of claim 23 the superimposing means includes means for frequency keying the first data onto the carrier signal.

28. The ground station of claim 23 including a second sensing means for measuring temperature at the ground station and generating temperature data representative thereof; and wherein the transmitter comprises means for superimposing the temperature data onto the carrier signal.

29. The ground station of claim 23 wherein the sensing means comprises a solid state sensor for measuring both barometric pressure and temperature at the ground station and generating pressure and temperature data respectively representative thereof.

30. The ground station of claim 23 wherein the transmitter comprises a VHF radio transmitter.

31. Apparatus disposed at an aircraft for determining an altitude of the aircraft using barometric pressure measurements, said apparatus comprising:
a receiver for receiving a signal transmitted from a ground station, said signal including first data representative of barometric pressure at said ground station;
sensing means for measuring barometric pressure at the altitude of said aircraft and generating second data representative thereof; and
processing means for determining the altitude of said aircraft based on said first and second data and data representative of the elevation of said ground station.

32. The apparatus of claim 31 wherein the first data is superimposed on a carrier of the transmitted signal; and wherein the receiver includes means for separating the first data from the carrier.

33. The apparatus of claim 31 wherein the sensing means includes a solid-state pressure sensor (SSPS).

34. The apparatus of claim 33 wherein the SSPS comprises a resistance bridge strain sensor.

35. The apparatus of claim 31 wherein the sensing means generates an analog signal representative of the measured pressure and includes means for digitizing the analog signal into a digital data word.

36. The apparatus of claim 31 wherein the signal received by the receiver includes third data representative of temperature at the ground station; and wherein the processing means includes means for compensating the first data with the third data.

37. The apparatus of claim 31 including a second sensing means for measuring temperature at the aircraft and generating third data representative thereof; and wherein the processing means includes means for compensating the second data with the third data.

38. The apparatus of claim 31 wherein the sensing means comprises a solid state sensor for measuring both barometric pressure and temperature at the aircraft and generating second and third data respectively representative thereof.

39. The apparatus of claim 31 including a memory for storing elevation data of the ground station; and wherein the processor includes means for determining the altitude of said aircraft based on said first and second data and elevation data of the ground station accessed from said memory.

40. The apparatus of claim 31 including means for determining a position of said aircraft and generating a position signal representative thereof; a terrain data base for storing data representative of elevations of the terrain under a flight path of the aircraft; and means for accessing terrain elevation data from said data base based on the position signal.

41. The apparatus of claim 40 wherein the processing means includes means for determining aircraft AGL at an aircraft position based on the determined altitude and the accessed terrain elevation data at said aircraft position.

42. The apparatus of claim 40 wherein the position determining means comprises a GPS receiver.

43. The apparatus of claim 40 wherein the processing means includes means for determining projected aircraft AGL along a flight path of the aircraft based on determined altitude of the aircraft and accessed terrain elevation data based on projected positions of the aircraft along said flight path.

44. The apparatus of claim 31 wherein the receiver comprises a VHF radio receiver.

45. Method of determining an altitude of an aircraft using barometric pressure measurements, said method comprising the steps of:
transmitting a signal from a ground station to said aircraft, said signal including first data representative of barometric pressure at said ground station;
receiving said transmitted signal at said aircraft;
measuring barometric pressure at the altitude of said aircraft and generating second data representative thereof; and
determining the altitude of said aircraft based on said first and second data and data representative of the elevation of said ground station.

46. The method of claim 45 including the steps of measuring barometric pressure at the ground station and generating the first data representative thereof.

47. The method of claim 46 wherein the barometric pressure at the ground station is measured by a solid-state pressure sensor (SSPS).

48. The method of claim 46 wherein the first data is generated as an analog signal representative of the measured pressure; and including the step of digitizing the analog signal into a digital data word.

49. The method of claim 46 including the step of superimposing the first data onto the carrier of the transmitted signal.

50. The method of claim 49 wherein the step of superimposing includes frequency keying the first data onto the carrier of the transmitted signal.

51. The method of claim 46 including the steps of measuring temperature at the ground station and generating third data representative thereof; and superimposing the first and third data onto the carrier of the transmitted signal.

52. The method of claim 45 including the steps of measuring both barometric pressure and temperature at the ground station and generating first and third data respectively representative thereof with a common solid state pressure sensor.

53. The method of claim 45 wherein the transmitted signal is transmitted by a VHF radio transmitter.

54. The method of claim 45 including the steps of superimposing the first data onto a carrier of the transmitted signal; and separating the first data from the carrier at the aircraft.

55. The method of claim 45 wherein the barometric pressure at the aircraft is measured by a solid-state pressure sensor (SSPS).

56. The method of claim 45 wherein the measured barometric pressure at the aircraft is generated as an analog signal; and including the step of digitizing the analog signal into a digital data word.

57. The method of claim 45 including the steps of measuring temperature at the aircraft and generating third data representative thereof; and compensating the second data with the third data.

58. The method of claim 45 including the steps of transmitting the signal from the ground station that includes third data representative of temperature at said ground station; and compensating the first data with the third data.

59. The method of claim 45 including the steps of measuring both barometric pressure and temperature at the aircraft and generating second and third data respectively representative thereof with a common solid-state pressure sensor.

60. The method of claim 45 including the steps of storing elevation data of the ground station at the aircraft; determining the altitude of said aircraft based on said first and second data and the stored elevation data of the ground station.

61. The method of claim 45 including the steps of determining a position of said aircraft and generating a position signal representative thereof; storing data representative of elevations of the terrain under a flight path of the aircraft; and accessing the stored terrain elevation data based on the position signal.

62. The method of claim 61 including the step of determining aircraft AGL at an aircraft position based on the determined altitude and the accessed terrain elevation data at said aircraft position.

63. The method of claim 61 wherein the position of the aircraft is determined by a GPS receiver.

64. The method of claim 61 including the step of determining projected aircraft AGL along a flight path of the aircraft based on determined altitude of the aircraft and accessed terrain elevation data based on projected positions of the aircraft along said flight path.

65. The method of claim 45 wherein the transmitted signal is received by a VHF radio receiver.
